(19) United States
(12) Patent Application Publication
(10) Pub. No.: US 2002/0086046 A1
(43) Pub. Date: Jul. 4, 2002

(54) Composition and methods for controlling molluscs

(76) Inventors: Greg Deitch, Heidelberg Victoria (AU); Russell Brown, Heidelberg Victoria (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/921,449

(22) Filed: Aug. 2, 2001

(30) Foreign Application Priority Data
Aug. 4, 2000 (AT) PQ 9173

(51) Int. Cl. A01N 25/08; A01N 55/02

(52) U.S. Cl. 424/410; 514/499

(57) ABSTRACT

The present invention provides compositions and methods for controlling terrestrial molluscs. In one aspect, compositions of the present invention are ingestable poisons that are lethal to terrestrial molluscs. In particular, compositions of the present invention comprise an active ingredient for controlling terrestrial mollusc, wherein the active ingredient comprises a complex of edetic acid (i.e., ethylene diamine tetra-acetic acid or EDTA), preferably a metal EDTA complex.

### FIELD OF THE INVENTION

The present invention relates to compositions and methods for the control of terrestrial molluscs. More particularly the invention relates to an effective, readily ingestable poison that is lethal to terrestrial molluscs.

### BACKGROUND OF THE INVENTION

Terrestrial pulmonate gastropods, slugs and snails (collectively, molluscs) are significant plant pests that affect commercial agriculture, horticulture and domestic gardens. These molluscs are omnivorous and consume large amounts of vegetative materials during their daily foraging. Consequently, they can seriously damage vegetable gardens and plant crops during all phases of the growth cycle. Because of the destructive potential of terrestrial molluscs, control measures must be employed to ensure adequate protection of the growing plants.

A wide variety of approaches have been used to try to combat mollusc pests. Perhaps the most common is the use of poisonous actives called molluscicides. Molluscicides include a diversity of chemical compounds such as table salt (NaCl), calcium arsenate, copper sulfate, mesurol and metaldehyde. Molluscicides fall into two major categories based on their mode of action—(1) contact poisons, and (2) baits, which include ingestible poisons.

Contact poisons are molluscicides that must come into physical contact with the exterior of the mollusc in order to be effective. Physical contact usually occurs either by external application or through the action of the mollusc traversing a molluscicidal composition placed on the ground. The contact molluscicide is picked up by the proteinaceous slime coat of the mollusc and builds up in the body of the mollusc until a lethal level is reached.

One of the major drawbacks of contact molluscicides is that they have little effect if the molluscs do not have sufficient physical contact with the chemical agents. If the molluscs are hidden or migrate to a different area after a contact molluscicide is spread, they are unaffected. For these reasons, contact-acting mollusc poisons are generally considered to be unreliable.

Mollusc baits must be ingested by a mollusc in order to be lethal. Baits tend to be preferred over contact poisons because baits are considered more reliable.

One challenge associated with the development of effective mollusc bait is preparation of a composition that is both palatable to the mollusc and is effective in delivering a lethal poison. Obviously, a sufficient quantity of the poison must be ingested to reach the lethal threshold. Often, compositions that are palatable to the mollusc are not effective as a lethal poison, while compositions that are quite potent and lethal are often not readily ingested by molluscs or are repellents.

Many contact poisons, such as aluminum sulfate, copper sulfate and borax, are useless as ingestable poisons for baits because they are so unpalatable, the molluscs will not ingest a lethal dose. Baits must be sufficiently palatable that a mollusc will build up the dose of poison in its system, but the poison must also be slow acting enough to prevent the mollusc from becoming sick or cause it to cease feeding.

Typical problems associated with the development of compositions for the effective control of molluscs are discussed by Henderson, et al. in Aspects of Appl. Biol., 1986, 13, 341-347. This publication recognizes that although many compounds are known to be poisonous to molluscs, there is considerable difficulty in delivering the poison to the mollusc either as bait or as a contact poison. The potential toxicity of a compound is irrelevant if molluscs will not consume a lethal dose of a bait poison.

One of the few compounds that can be used as either a contact or bait poison for terrestrial molluscs is metaldehyde. This compound is commonly used as a long lasting bait, attracting molluscs and killing them after ingestion. While metaldehyde has high effectiveness and commercial popularity, it has the serious drawback of being toxic to higher mammals and is a major contributor to domestic animal poisoning in the United States, Europe and Australia.

Therefore there is need to develop an effective ingestable poison for molluscs that is palatable to molluscs yet does not pose a threat to the environment, crops, animals and other non-pests.

Accordingly, it is an object of the invention to provide a composition and method for killing terrestrial molluscs that is palatable to the molluscs and overcomes one or more of the problems associated with the baits of the prior art.

### BRIEF SUMMARY OF THE INVENTION

One aspect of the present invention provides a composition comprising an active agent for controlling terrestrial molluscs and methods for using the same. The active agent comprises a metal salt of EDTA, metal EDTA complex or mixtures thereof.

In one particular embodiment, the composition for controlling terrestrial molluscs is an ingestable composition.

In another embodiment, the present invention provides a molluscicidal bait comprising the composition described herein.

Terrestrial molluscs can be controlled by applying to a substrate a composition described herein, and exposing the substrate to the mollusc. Terrestrial molluscs can also be controlled by applying a composition described herein to an area to be controlled.

### DETAILED DESCRIPTION OF THE INVENTION

As used herein, “EDTA” refers to edetic acid, also known as ethylene diamine tetra-acetic acid. In addition, a reference to a complex of EDTA includes complex salts and coordination compounds of EDTA.

As used herein, an “inert component” refers to a component which when admixed with an active agent of the present invention does not significantly reduce the activity of the active agent.

The present invention provides a composition comprising an active agent for controlling terrestrial molluscs, wherein the active agent comprises a metal salt of EDTA, metal EDTA complex or mixtures thereof, and methods for using the same.

The metal can be any metal capable of forming a salt or a complex with edetic acid. Preferably, the metal is a Group IB element of the Periodic Table, e.g., Cu, Ag, Au, etc. More preferably, the metal is copper.

The composition of the present invention can also include a carrier. The carrier can be of any suitable form. Typically, the carrier is an inert carrier, preferably an inert carrier that is readily consumed by molluscs. Any of the suitable inert carriers known to one skilled in the art can be used in the compositions of the present invention. Such inert carriers include, but are not limited to, agar, dextrose agar, gelatine, oil cake, pet food, cereal, fruits, fish by-products, sugars, malt, vegetable matter, casein, blood meal, bone meal, yeast, fats, paper and colorant. The preferred inert component is wheat cereal which is commercially readily available from various sources.

In one particularly preferred embodiment, the composition for controlling terrestrial molluscs comprises an inert carrier and a copper EDTA complex. Preferably, the amount of copper in the composition is in the range of from about 10 ppm to about 200,000 ppm, more preferably in the range of from about 17 ppm to about 27,000 ppm. Still more preferably, the concentration of copper in the composition is in the range of from about 2,500 to about 10,500 ppm.

Suitable copper EDTA complexes for use in the composition of the present invention will be readily apparent to the skilled in the art. In a preferred embodiment the copper EDTA complex is Cu-EDTA and/or Cu₂-EDTA, which are illustrate below.

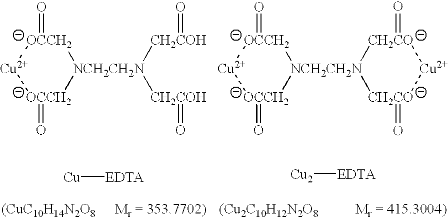

The composition of the present invention can be used alone or can be applied to a substrate to control terrestrial molluscs. The substrate can be any suitable form known to one skilled in the art. It will typically be a foodstuff normally consumed by a terrestrial mollusc, including a plant leaf and a seed, such as vegetable or cereal seeds. It can also be a mineral substrate, such as dolomite chips. Other substrates are envisaged within the scope of the present invention.

The composition can be applied to the substrate using any of the methods known to one skilled in the art, such as by coating. Alternatively, the composition and the substrate can be combined as an intimate mixture. Without being bound by any theory, it is believed that compositions of the present invention are toxic to the mollusc, and ingestion of a sufficient quantity of such composition can be fatal to mollusc.

One of the advantages of the compositions of the present invention is that they are highly toxic to terrestrial molluscs (i.e., exhibit a high mollusc mortality rate) and are readily consumed by terrestrial molluscs. Another significant advantage is that the compositions of the present invention are relatively environmentally safe and pose very low threat to humans, animals or other non-pests. For example, copper EDTA complexes are considered safe and are often used in agriculture to apply to soil that has a copper deficiency.

Compositions of the present invention can also include additional formulation enhancing additives. Such additives include preservatives, anti-microbial agents, phagostimulants, waterproofing agents, and taste altering additives.

A variety of preservatives can be used effectively with this molluscicidal bait. Preservatives can normally be mixed with water to form a stock solution which would typically be added to the formulation at a concentration in the range of from about 10 ppm to about 50,000 ppm.

One or more phagostimulants can be added to the composition to attract molluscs and to induce molluscs to feed upon the composition. A variety of phagostimulants can be used, including sugars, malt, yeast products and casein. Sugars, such as sucrose, are among the more preferred phagostimulants. These additives are normally incorporated within the composition in a dry form. Typically, they can be added to the composition at a amount of about 1 to about 2.5% by weight of the total composition.

Waterproofing agents, that can also act as binders, can be added to the composition to improve the weather ability of the molluscicidal bait. These are typically water insoluble compounds such as waxy materials and other hydrocarbons. Examples of suitable waterproofing agents include, but are not limited to, paraffin wax, stearate salts, beeswax, and similar compounds. Waterproofing agents can be incorporated into the composition, in dry form, typically at a concentration of about 5 to about 12% by weight of the total composition.

The molluscicidal bait can also comprise a taste altering compound that render the composition unpalatable to higher animals. Suitable taste altering compounds include, but are not limited to, those having a bitter taste, for example, denatonium benzoate which is commercially available. These compounds typically are added at very low concentrations.

The molluscicidal bait of this invention is typically used in dry form and many of the constituent ingredients of the composition are included in dry form. However, it is useful to include an amount of water within the composition which is sufficient to form a damp pre-mix so that the ingredients can be more easily formed. Water is typically added at about 5 to about 90% by weight of the total composition.

As noted above, the bait of the present invention can be used in any convenient form and is typically used as a powder, granules, cubes, pellets, sprays or gels. The composition can be spread on or around areas infested by molluscs as well as in areas in which it is desirable to prevent mollusc infestation.

The present invention also provides a method of preparing a mollusc bait comprising the steps of blending the active component with one or more inert components and any optional additives. For example, mollusc baits according to the present invention can be prepared as follows: a suitable amount of the active ingredient is blended, in dry form, with a dry inert component such as wheat flour. Thereafter, optional additives (such as phagostimulants and waterproofing agents) are blended and mixed with the other components. Next, suitable amounts of liquid optional additives (such as preservatives, taste altering components and water) are added to the dry mixture to form a damp pre-mix. The pre-mix can then be made into a desired form, such as a powder, granules, cubes, pellets, spray or gel.

Alternatively, the mollusc bait of the present invention can be prepared by coating a suitable inert component with at least one EDTA complex. Typically the inert component is vegetable matter, cereal or mineral matter. It is particularly preferred that the coated inert component is vegetable seed, cereal grain or dolomite.

Additional objects, advantages, and novel features of this invention will become apparent to those skilled in the art upon examination of the following examples thereof, which are not intended to be limiting.

### EXAMPLES

Molluscicidal baits were prepared according to the general procedure discussed above. The active ingredient precursors were added in sufficient amounts to yield the different concentrations of copper (present as copper EDTA) in the bait (see Table 1):

TABLE 1
Active concentrations in trial baits.

| Bait Identifier | Copper Concentration |
|---|---|
| T1 | 2,500 ppm |
| T2 | 5,000 ppm |
| T3 | 7,500 ppm |
| T4 | 10,000 ppm |
| Control | 0 ppm |

The control was prepared in a similar manner, except that it did not include the active ingredient copper EDTA.

Test were conducted in 30 cm×45 cm×5 cm plastic containers. Duplicate tests were carried out for each of the different bait active concentrations with common garden snails (helix aspersa), Italian white snail (theba pisana) and slugs (deroceras reticulatum). Each trial had 10 snails or slugs introduced to the trial containers (see Table 2, Table 3 and Table 4):

TABLE 2
Description of the different trials with helix aspersa.

| Trial Identifier | Copper Concentration |
|---|---|
| T1 HA1 | 2,500 ppm |
| TI HA2 | 2,500 ppm |
| T2 HA1 | 5,000 ppm |
| T2 HA2 | 5,000 ppm |
| T3 HA1 | 7,500 ppm |
| T3 HA2 | 7,500 ppm |
| T4 HA1 | 10,000 ppm |
| T4 HA2 | 10,000 ppm |
| Control HA1 | 0 ppm |
| Control HA2 | 0 ppm |

TABLE 3
Description of the different trials with theba pisana.

| Trial Identifier | Copper Concentration |
|---|---|
| T1 W1 | 2,500 ppm |
| TI W2 | 2,500 ppm |
| T2 W1 | 5,000 ppm |
| T2 W2 | 5,000 ppm |
| T3 W1 | 7,500 ppm |
| T3 W2 | 7,500 ppm |
| T4 W1 | 10,000 ppm |
| T4 W2 | 10,000 ppm |
| C W1 | 0 ppm |
| C W2 | 0 ppm |

TABLE 4
Description of the different trials with deroceras reticulatum.

| Trial Identifier | Copper Concentration |
|---|---|
| T1 S1 | 2,500 ppm |
| T1 S2 | 2,500 ppm |
| T2 S1 | 5,000 ppm |
| T2 S2 | 5,000 ppm |
| T3 S1 | 7,500 ppm |
| T3 S2 | 7,500 ppm |
| T4 S1 | 10,000 ppm |
| T4 S2 | 10,000 ppm |
| Control S1 | 0 ppm |
| C S2 | 0 ppm |

Each tray was floored with damp potting soil and covered with a transparent, plastic lid with air holes. Ten grams of the formulations identified above in Table 1 were placed inside a Petri dish and put in each plastic tray along with a lettuce plant. The plastic containers were placed outside in the shade during the course of the experiment.

The following observations were made 4 days after the snails and slugs were placed in the trial containers.

| | # of | Amt. of Pellet | % |
|---|---|---|---|
| Trial | Dead Molluscs | Consumed (g) | Lettuce Consumed |
| T1 HA1 | 6 | 4.6 | 10 |
| T1 HA2 | 5 | 5.1 | 5 |
| T2 HA1 | 8 | 4.5 | 10 |
| T2 HA2 | 9 | 3.9 | 0 |
| T3 HA1 | 10 | 3.8 | 0 |
| T3 HA2 | 10 | 4.0 | 5 |
| T4 HA1 | 10 | 2.5 | 0 |
| T4 HA2 | 10 | 3.0 | 5 |
| Control HA1 | 0 | Not Applicable | 95 |
| Control HA2 | 0 | Not Applicable | 95 |
| T1 W1 | 7 | 4.9 | 15 |
| T1 W2 | 7 | 4.6 | 30 |
| T2 W1 | 8 | 3.2 | 5 |
| T2 W2 | 9 | 4.1 | 5 |
| T3 W1 | 10 | 4.4 | 0 |
| T3 W2 | 10 | 5.0 | 0 |
| T4 W1 | 10 | 3.5 | 0 |
| T4 W2 | 10 | 3.1 | 0 |
| Control W1 | 0 | Not Applicable | 100 |
| Control W2 | 0 | Not Applicable | 95 |
| T1 S1 | 5 | 7.4 | 15 |
| T1 S2 | 6 | 5.3 | 10 |
| T2 S1 | 9 | 6.1 | 5 |
| T2 S2 | 8 | 6.5 | 5 |
| T3 S1 | 10 | 7.3 | 0 |
| T3 S2 | 10 | 5.6 | 5 |
| T4 S1 | 10 | 4.7 | 0 |
| T4 S2 | 10 | 4.2 | 0 |
| Control S1 | 1 | Not Applicable | 95 |
| Control S2 | 0 | Not Applicable | 100 |

Pellets manufactured with 7,500 ppm and 10,000 ppm achieved a 100% kill rate. The lower concentrations although effective (a 100% kill rate was observed on day 8 for the 2,500 ppm and 5,000 ppm products) the snail and/or slugs were able to cause significant damage to the lettuce plant.

Whilst it has been convenient to describe the invention herein in relation to particularly preferred embodiments, it is to be appreciated that other constructions and arrangements are considered as falling within the scope of the invention. Various modifications, alterations, variations and/or additions to the constructions and arrangements described herein are also considered as falling within the scope and ambit of the present invention.

What is claimed is:

1. A composition comprising an active ingredient for controlling terrestrial molluscs, wherein said active ingredient comprises a metal salt of EDTA, a metal EDTA complex or a mixture thereof.

2. The composition according to claim 1, wherein the metal is a Group IB metal of the Periodic Table.

3. The composition according to claim 2, wherein the metal is copper.

4. The composition according to claim 3, wherein the metal EDTA complex is Cu-EDTA, Cu₂-EDTA or a mixture thereof.

5. The composition according to claim 1, wherein said composition is in the form of an ingestable bait.

6. The composition according to claim 1 further comprising a carrier.

7. The composition according to claim 6, wherein said carrier is inert.

8. The composition according to claim 6, wherein said carrier is selected from the group consisting of agar, dextrose, agar, gelatine, oil cake, pet food, cereal, fruit, fish by-product, sugar, malt, vegetable matter, casein, blood meal, bone meal, yeast, fat, paper, colorant, mineral substrates and mixtures thereof.

9. The composition according to claim 1 further comprising a formulation enhancing additive.

10. The composition according to claim 9, wherein said formulation enhancing additive is selected from the group consisting of preservative, anti-microbial agent, phagostimulant, waterproofing agent, taste altering additive and mixtures thereof.

11. The composition according to claim 1, wherein the concentration of the metal in the composition is in the range of from about 10 to about 200,000 ppm.

12. The composition according to claim 1, wherein the concentration of metal in the composition is in the range of from about 17 to about 27,000 ppm.

13. The composition according to claim 12, wherein the concentration of metal in the composition is in the range of from about 2,500 to about 10,000 ppm.

14. The composition according to claim 9, wherein the additive is a preservative which is present in the composition at a concentration in the range of from about 10 to about 50,000 ppm.

15. The composition according to claim 9, wherein the additive is a phagostimulant which is present in the composition at a concentration in the range of from 1 to about 2.5% by weight of the composition.

16. The composition according to claim 9, wherein the additive is a waterproofing agent which is present in the composition at a concentration in the range of from of 5 to 12% by weight of the bait.

17. A method for controlling terrestrial molluscs comprising applying to a substrate or an area to be controlled a composition of claim 1 or placing mollusc bait to the area to be controlled, wherein said mollusc bait comprises a composition of claim 1.

18. The method according to claim 17, wherein said substrate is a foodstuff normally consumed by a terrestrial mollusc.

19. The method according to claim 18, wherein said mollusc bait comprises vegetable seeds, cereal grains or dolomite coated with said composition.

20. A composition comprising an active ingredient for controlling terrestrial molluscs, wherein said active ingredient comprises a Cu-EDTA complex, a Cu₂-EDTA complex or mixtures thereof, and an inert carrier, the composition being provided in liquid or dry form.
